(19) United States
(12) Patent Application Publication
(10) Pub. No.: US 2014/0064489 A1
(43) Pub. Date: Mar. 6, 2014

(54) METHOD, SYSTEM AND DEVICE FOR ENCRYPTION KEY MATERIAL ERASURE

(71) Applicant: Hans Willy FLISNES, Alesund (NO)

(72) Inventor: Hans Willy FLISNES, Alesund (NO)

(73) Assignee: HIGH DENSITY DEVICES AS, KOKSTAD (NO)

(21) Appl. No.: 13/600,725

(22) Filed: Aug. 31, 2012

(51) Int. Cl. G06F 21/00

(52) U.S. Cl. 380/277

(57) ABSTRACT

Method, system and device for generating a signal requesting the execution of deletion of encryption key material in a computer system where the method includes providing a key zeroize activation device (100) attached to the computer system (7) and where the key zeroize activation device (100) provides a zeroizing button (1) mounted within the device (100), and where the zeroizing button (1) generate a request signal when operated.

### FIELD

The invention relates to a method, system and device for instant user initiation of erasure of encryption keys and encryption key material associated with encryption of any stored information in a computer system or a system comprising a multitude of computer systems.

### BACKGROUND

The use of IT systems and computers are becoming more and more important. Frequently systems are used in unpredictable environments where stable operational conditions may be interrupted at short notice. Such systems may also comprise the handling and storage of highly sensitive information. Examples of such situations are operations in politically unstable areas, or operations threatened by natural forces or human hostilities. It can be represented by a government operation in hostile countries, such as an Embassy network, or it can be military operations in a war zone. Even rescue operations and famine aid operations often carry vast quantities of IT equipment comprising sensitive stored information.

The task of securing the information and preventing it from falling into the hands of unauthorized people and the acute need to securely abandon computer hardware in the field on short notice is the object of products offered in the market.

These products may comprise of mechanisms and components seeking to destroy all hardware containing sensitive information by physical means. In some cases, this may involve the use of explosives or shooting the hard disk to prevent unauthorized access to data. Some solutions provide “melting” capabilities, magnet radiation or powerful grinders to destroy and make unavailable sensitive data on storage media.

Other solutions, in particular software encryption, implement software algorithms that repeatedly write 0's and 1′ to all storage locations on the disks comprising the sensitive information.

What is common for the majority of these products are that they are resource demanding, time consuming and usually only scalable to a small number of computers at any given time, very often requiring lengthy destruction processes that need manual monitoring and supervision.

Encryption systems are employed to protect sensitive data, either when in transit or when stored, and may be implemented in hardware, software, or a combination of both. For the encryption to work, the encryption system must be initiated by making available one or more encryption keys, and one or more encryption algorithms. The encryption key(s) are then available for the computer system either stored in a storage device or memory for more permanent keeping, or stored in volatile memory for a defined time period or as long as the computer is powered. Other validity schemes for the encryption keys may be implemented.

The problem with many of the systems discussed above is that the safeguarding of sensitive information and when applicable encryption keys extends beyond safeguarding of the data/encryption alone, as in a critical situation there may not be time to shut down the system prior to abandoning the equipment, implying leaving behind the system with the data/encryption key still active (in memory). The problem becomes even more evident when a system is comprised of a number of computers.

### SUMMARY OF THE INVENTION

The present invention solves the above discussed problems, where a computer, a computer system or a plurality of such, implements encryption using one or more encryption keys. The invention comprises a method and system for initiating immediate erasure of encryption key material used, processed and stored, and further comprise a device located in easy access range for an operator initiating the destruction or erasure of encryption key material in the computers in question with a fast, reliable and user-friendly mechanism, safeguarded against user errors, by implementing the encryption key material destruction through the operation of one or more hardware zeroize buttons.

The encryption key material is thereby not prone to unauthorized disclosure in an emergency situation and data and data systems depending on and using the encryption key material are therefore no longer to be considered a major security risk.

### BRIEF DESCRIPTION OF THE FIGURES

FIG. 1 illustrates one embodiment of the invention without the protective cover, and where the key token is not inserted.

FIG. 2 illustrates one embodiment of the invention where the interior is made visible.

FIG. 3 illustrates one embodiment of the invention, the storage media of a computer and a computer system.

FIG. 4 illustrates one embodiment of the invention connected to a computer system.

FIG. 5 is a flow diagram of the key zeroizing process in the encryption system.

FIG. 6 is a flow diagram of the key zeroize process in the key token.

FIG. 7 is a system overview of a key zeroize scheme where several computers and computer systems are connected to one, or more, key zeroize activation device(s).

### DETAILED DESCRIPTION OF THE INVENTION

It shall be understood that the illustrations and descriptions of the present invention and its components are included in the document as examples of embodiments of the method and mechanism of the invention. The invention may be designed in many variations and configurations and the illustrations and embodiments are therefore not intended to limit the scope of protection of the invention as claimed, but represent only selected embodiments of the invention. A person skilled in the art may use the different described aspects of the invention in different configurations without diverting from the scope of protection of the invention.

The invention is designed to be adaptable in a number of different configurations, and as the following describe a computer system it shall be understood that this may comprise a single computer, such as a personal laptop, desktop or server, a computer system comprised of more than one computer or storage unit, and a number of computer systems sharing the same scheme for protecting the key material of the encryption system or encryption systems.

It shall also be understood that when the phrase “key material” is used this comprise all types of encryption key material included in the system, including, but not limited to, passwords generated by and stored in the computer system, parts of or complete sets of single or multiple encryption keys downloaded and/or imported from key tokens or input directly by a computer system operator or input via one or more network lines, or parts of or complete encryption keys stored in the computer system.

The terms “delete”, “erase”, and “zeroize” used to describe the process of deleting key material shall be understood to comprise of deletion by erasing references to the key material, zeroizing as actively writing zeroes to all or parts of the data bits of the storage locations of the key material, and even more thorough deletion methods described by more rigid deletion schemes, such as repeatedly writing alternate 0's and 1's to defined storage locations of the key material.

In one embodiment of the invention there is provided a physically separate unit for storage of key material, connectable to a computer or computer system. The unit, the key zeroize activation device, comprise an initiating device, e.g. a zeroize button, that when operated initiate erasure of key material in the computer or computer system by sending an activation signal for zeroizing and deletion of encryption key material located and stored in the computer or computer system the connectable unit is connected to. The initiating device can be any type of activation device or combinations thereof, including but not limited to a button, switch, sensor and/or others.

In another embodiment of the invention, the initiating device is connected directly to the computer or computer systems via a connector interfacing with the computer system(s). This may also be implemented as a permanently fixed integral part of the computer or computer system.

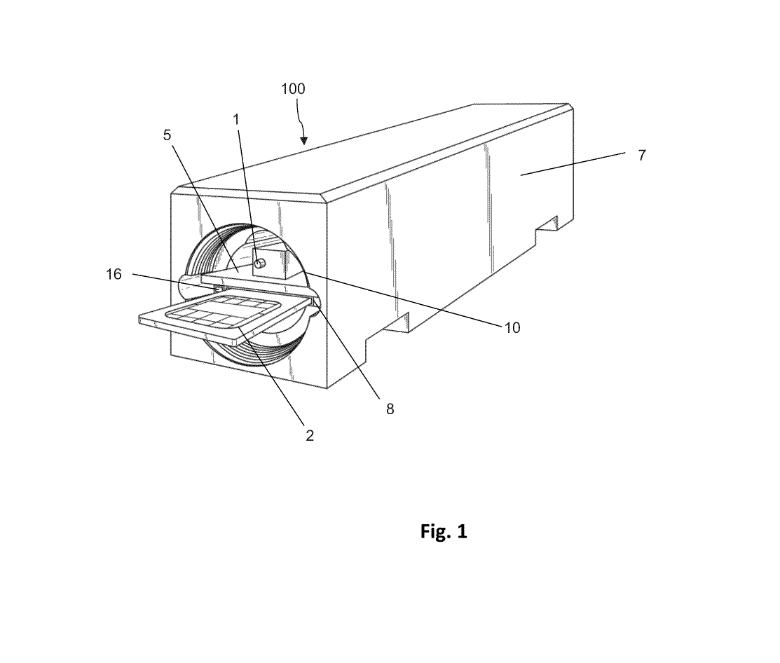

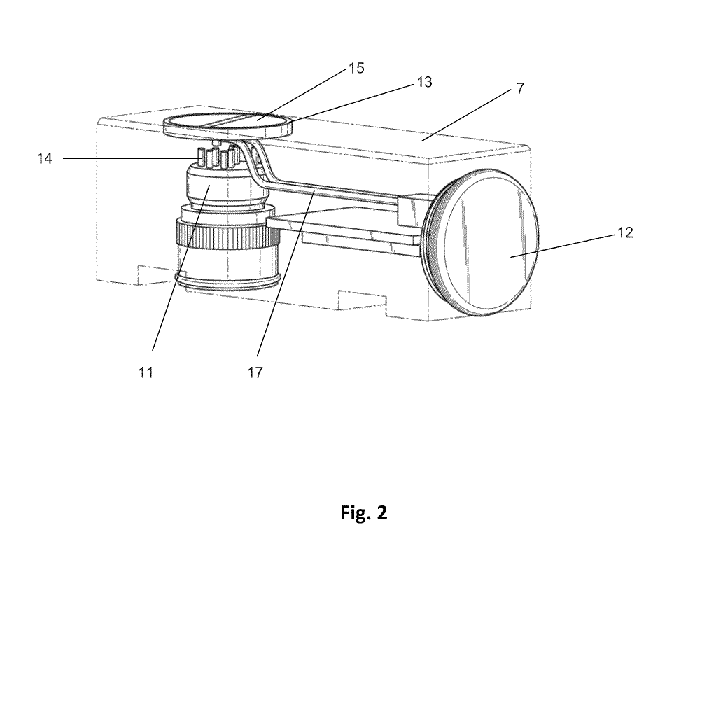

FIG. 1 illustrates an embodiment of the invention, the key zeroize activation device 100 comprise a zeroize button 1 connected to a printed circuit board 5, the printed circuit board 5 comprising a contact device 8 for a key token 2, such as a smart card. The zeroize button 1, printed circuit board 5 and the contact device 8 is mounted inside a unit 7 with an opening 10 in a first end of the unit 7 giving access from the outside to the zeroize button 1, printed circuit board 5 and the contact device 8. The opening 10, providing access to the zeroize button 1, printed circuit board 5 and the contact device 8, may be covered by a protective cover 12, as shown in FIG. 2, to prevent unintentional access to the inside of the unit 7. The cover 12 may be designed for quick lock and release, more safely attached by for example a physical key lock, or made out of breakable materials (e.g. glass) permanently fixed to the opening.

The printed circuit board 5 comprises electrical contacts and lines 17 for communication of signals and information between the zeroize button 1 and the contact device 8 and a further electrical connector 11 located at a second end of the container 7. The electrical connector 11 is intended to connect to a computer system. Signals pass through the printed circuit board 5 through the lines 17 and the electrical connector 11 to the computer system. Signals passed through electrical connector 11 to computer system may be, but not limited to, lines 17 for status indicator, key token, zeroize mechanism and power source. The unit 7 and the electrical connector 11 may be designed for quick lock and release, or it may be more permanently connected once mounted, for example by being designed with female threading intended for being screwed onto a threaded contact in connection with the computer system, alternatively a bayonet coupling, soldering or other may be used. The unit 7 may further provide an emergency access 13 to the backside contact connectors 14 of the electrical connector 11 inside the unit 7. The emergency access 13 is covered by a protective cover 15. The printed circuit board 5 may further provide communication lines between the zeroize button 1 and the contact device 8. The key zeroize activation device 100 may further comprise a status indicator 16 providing visual, audio or motion signals, or a combination thereof, such as one or more LED, identifying the status of the parts comprised in the key zeroize activation device 100. The status indicator 16 may even be connected to the attached computer system through the electrical connector 11, and be used for receive and indicate the status of the attached computer system.

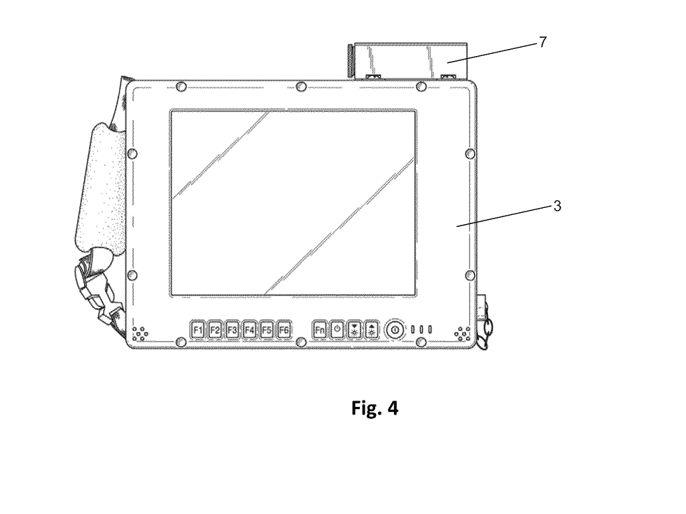

In the embodiment of the invention as shown in FIG. 1, a zeroize button 1 is connected to a printed circuit board 5, and a key token 2 is about to be inserted and in contact with the contact device 8. The printed circuit board is mounted inside the unit 7. In FIG. 4 the unit 7 is connected to a computer 3 via the electrical connector 11. The unit 7, the printed circuit board 5, the key token 2, the zeroize button 1 and the electrical connector 11 comprises a detachable unit for key storage and transfer. The deletion of encryption key material is initiated by operating the zeroize button 1. When the zeroize button 1 is operated, an activation signal is generated and the signal is transferred through the electrical connector 11 to the computer system which in turn initiates deletion of encryption key material in the computer system.

In another embodiment of the invention, the zeroize button 1 may generate a signal that is inputted to the key token 2, whereupon the key material on the key token 2 is deleted. This signal may be handled by optional logic comprised in the unit 7, like a microcontroller, and power that is obtained from an optional power source, both which may be embedded on the printed circuit board 5. The key token 2 may be composed of a memory unit containing the whole or part of key material necessary to key the encryption system of the connected computer system 3, or the key token 2 may be composed of a smart card connectable to the printed circuit board 5 to enable communication of the key material from the key token 2 to the storage device on the detachable unit. The design of the detachable unit of the invention device is preferably such that the zeroize button 1 is easily accessible from the outside of the detachable unit, but is protected from accidental operation. The zeroize button will when operated send a signal representing a request for encryption key material zeroize in the encryption system attached thereto, and a zeroize device in the encryption system will optionally zeroize key material in the computer system.

In one embodiment of the invention the key zeroize activation device is implemented solely in hardware. This implies that no operation of software is necessary to ensure proper zeroizing of key material.

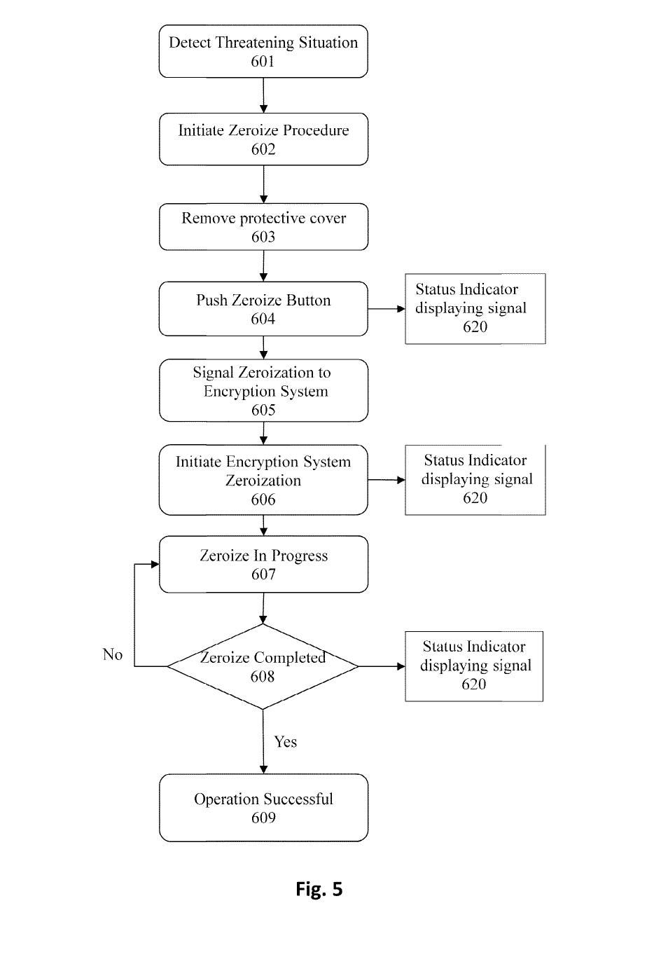

A flow diagram of an embodiment of a method for key zeroize in the encryption system is shown in a sequence flow diagram in FIG. 5. The method comprise of identifying a threatening or emergency situation 501 and decide to initiate the zeroize procedure 502. Remove 503 the protective cover 12 of the key zeroize activation device to access and operate the zeroize button 504. The zeroize button passes signals to the encryption system 505 which in turn initiates the zeroizing process 506. Zeroize starts 507 and ends 508 with a status indicator returning signal indicating operation successful 509. Furthermore, decide, if time permits, further preventive actions, and if yes remove the key token 2 or the whole unit 7 from the computer system. The status indicator may display status 520 every time a message is initiated or received by the zeroize activation device 100.

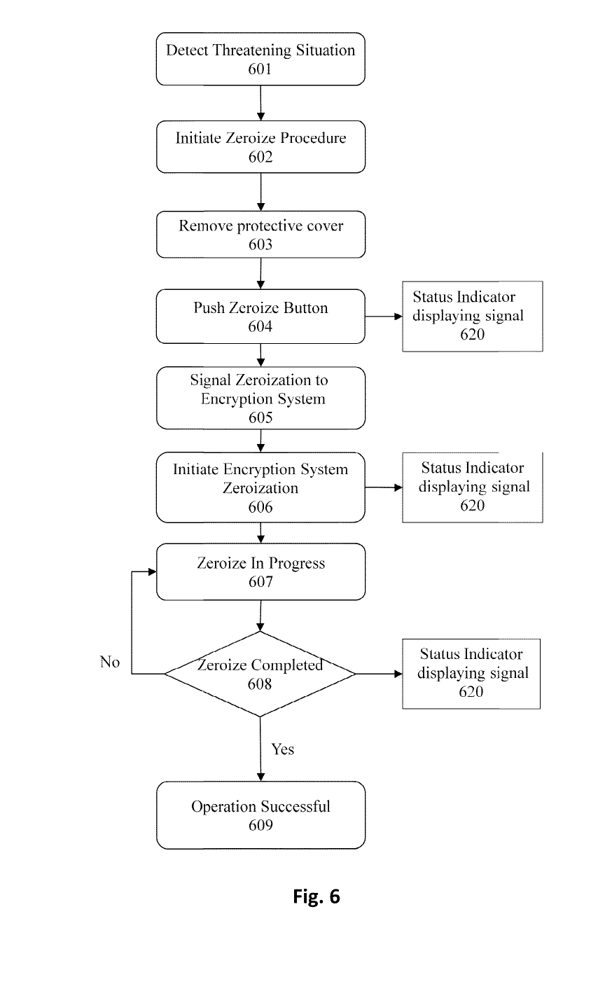

Another flow diagram of another embodiment of a method for key zeroize in the key token is shown in a sequence flow diagram in FIG. 6. The method comprise to identify a threatening or emergency situation 601 and decide to initiate the zeroize procedure 602. Remove 603 the protective cover 12 of the key zeroize activation device to access and operate the zeroize button 604. The zeroize button passes signals to the local controller 605 which in turn sends a zeroize message to the key token 606. Zeroize starts 607 and ends 608 with a status indicator returning signal indicating operation successful 609. Furthermore, decide, if time permits, further preventive actions, and if yes remove the key token 2 or the whole unit 7 from the computer system. The status indicator may display status 620 every time a message is initiated or received by the zeroize activation device 100.

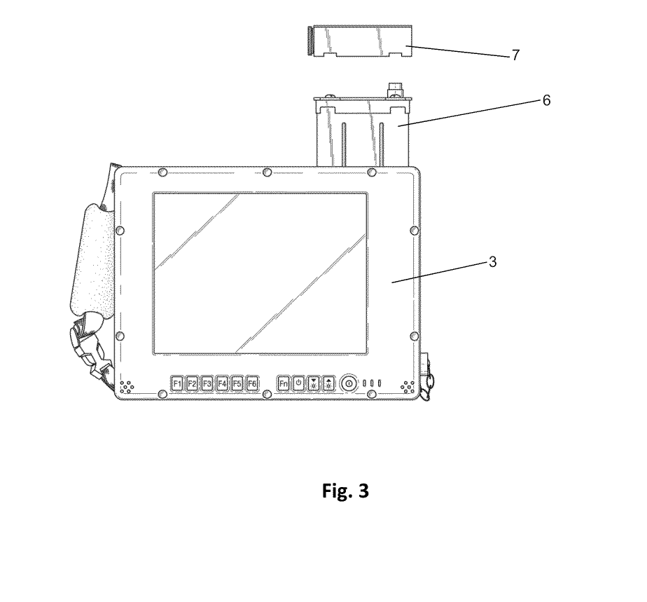

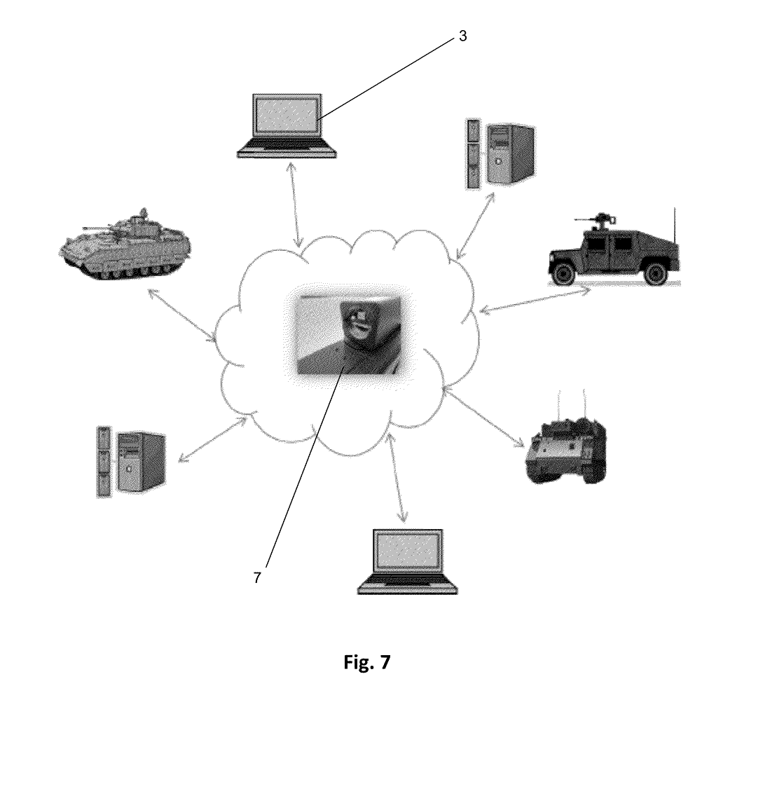

A system overview of a plurality of computers or computer systems where the key zeroize activation devices are connected in a separate network is shown in FIG. 7. The system shows that although the individual computer or computer system operate as standalone, the key zeroize function is connected to a number of encryption systems comprising of one or more storage media FIG. 3, 6, and a number of key tokens FIG. 1, 2. The system may even comprise several key zeroize activation devices 100 where a regime is constructed to enable initiation of erasure of key material based on defined sections of the overall system, where some key zeroize activation devices 100 will work on predefined system sections, whilst other will work on all. This enables the feature of being able to remotely control the key material throughout the entire system. A section is here merely an expression of a predefined number of identified computers or computer systems. A section may also be comprised of only one computer, storage 6 or computer system.

Another embodiment of the invention, the key zeroize activation device 100 is mounted in a series/set/rack of computer systems where the computer systems represents the controlling unit of an operation system comprising both sensitive and non-sensitive information and programs. The key zeroize function is implemented such that when activated by pushing the zeroize button 1, only the encryption key material operating the sensitive information and programs are deleted and disabled, whilst the non sensitive information and programs are still operable. This embodiment visualize how the invention can be used to customize and differentiate the impact of using the zeroize feature of the invention.

The key zeroize activation device 100 may in one embodiment comprise a communication device offering a communication protocol to provide a communication session that upon activation, when operating the zeroize button 1, not only sends a single activation signal, but implements a zeroize request message, which then may receive an acknowledgment and optionally an additional success or fail response from all or some of the connected key holders, these holders being the key token 2 and/or the connected computer systems 3. The response may be used to decide further actions by the operator or the key zeroize activation device 100, such as for input to the status indicator 16. The communication protocol may be implemented as a custom built protocol, or take advantage of already implemented communication protocols.

In one embodiment of the invention the method of zeroizing any key material stored in a key token may comprise customized hardware based or software based routines on the key token, specifically designed for quick erasure of encryption key material stored in the key token. This operation is designed to execute all deletion in a short enough time as to not compromise relevant key material.

The method may further comprise customized hardware based or software based routines on any number of connected computer systems, specifically designed for quick erasure of encryption key material stored in these. This operation is designed to execute all deletion in a short enough time as to not compromise relevant key material.

The description outlines the principles and embodiments of the present invention, and shall be regarded as illustrative rather than restrictive. The features and embodiments of the invention described can be combined in other combinations than those described explicitly. It should be understood that variations may be made by those skilled in the art without departing from the scope of the present invention as defined by the associated claims.

Reference signs mentioned in the claims should not be seen as limiting the extent of the matter protected by the claims, and their sole function is to make claims easier to understand.

1. A method for generating a signal requesting the execution of deletion of encryption key material in a computer system, the method comprising:
providing a key zeroize activation device (100) attached to the computer system (7),
the key zeroize activation device (100) providing a zeroizing button (1) mounted within the device (100), the zeroizing button (1) generate a request signal when operated.

2. The method of claim 1, further comprising:
communicating the request signal to a key zeroize device in the computer system (7), the key zeroize device in the computer system (7) being adapted to delete encryption key material stored in the encryption system in response to receiving the request signal.

3. The method of claim 1, where the key zeroize device in the computer system (7) further comprising:
communicating an encryption key material zeroizing successfully complete signal when encryption key material in the encryption system is deleted.

4. The method of claim 1, where the key token reader (8) comprising a key token (2), the method further comprise sending the request signal to a zeroizing device in the key token (2), the zeroizing device in the key token (2) being adapted to delete encryption key material stored in the key token (2) in response to receiving the zeroizing request signal.

5. The method of claim 4, where the zeroizing device in the encryption key token (2) further comprising:
communicating an encryption key material zeroizing successfully complete signal when encryption key material in the key token (2) is deleted.

6. The method of claim 1, further comprising
providing a status of the individual encryption key material deletion operations,
providing a status indicator (16) being adapted to present an identification of the status of the individual deletion of the encryption key material in response to the status of the individual encryption key material deletion operations.

7. The method of claim 1, further comprising:
providing a protecting cover 12 being positioned to protect the key zeroize activation device 100 from accidental operation,
removing the protecting cover (12) before operating the zeroizing button 1 inside the device (100).

8. A key zeroize activation device (100) unit comprising:
a first opening (10) arranged in a first end of the unit, an electrical connector (11) providing one or a multiple of electrical signal paths (17) from the inside of the unit to the outside of the unit arranged in a second end of the unit,
a zeroize button (1), being designed to be operated, mounted on a printed circuit board (5) inside the device (100) in proximity to the first opening (10) in the first end of the device (100),
the zeroize button (1) being electrically connected to the inside of the electrical connector (11) in the second end of the unit,
a protecting cover (12) placed over the first opening in the first end of the unit.

9. The unit of claim 8 further comprising:
a key token reader (8) being electrically connected to the zeroizing button (1).

10. The key token reader (8) of claim 9 being further electrically connected to the inward facing side (14) of the electrical connector (11) in the second end of the unit.

11. The key token reader (8) of claim 9 being mounted inside the unit.

12. The electrical connector (11) defined in claim 7 further being adapted to connect to one or a multiple of computer systems or a multiplexer connecting the device (100) to one or a multiple of computer systems.

13. The device (100) with the electrical connector (11) of claim 11 further comprising:
a programmable controller being programmed to initiate deletion of encryption key material in the attached computer systems (3) and key tokens (2) in a predefined order.

14. The unit of claim 8 further comprising:
a second opening (13) in the device (100) arranged in the second end of the device (100) giving access to the inward facing side (14) of the electrical connector (11), and a protecting cover (15) arranged to cover the second opening (13) in the device (100).

15. The device (100) of claim 8 further comprising:
a status indicator (16).

16. The status indicator (16) of claim 15 being electrically connected to a communication device comprised in the device (100), the communication device being connected to the computer system via the connector (11), and further optionally connected to the key token reader (8) via the printed circuit board (5) enabling a status message to be communicated from the attached computer systems and optionally from the key token (2) mounted inside the key token reader (8) to the status indicator (16).

17. The status indicator of claim 15 being electrically directly connected to the connector (11) and optionally directly connected to the key token reader (8).

18. A computer implemented encryption device that comprise an interrupt routine for deleting encryption key material upon being connected to the electrical connector (11) of the key zeroize activation device (100) defined in claim 8 and receiving a signal generated by the operation of the zeroize button (1) in the device (100).

19. The computer implemented encryption device of claim 18 further comprising a signaling device communicating a status signal representing the delete status of the encryption key material back to the electrical connector (11).

20. A computer implemented encryption key token that comprise an interrupt routine for deleting encryption key material upon being connected to the device (100) defined in claim 9 and receiving a signal generated by the operation of the zeroize button (1) in the device (100).

21. The computer implemented encryption key token of claim 20 further comprising a signaling device communicating a status signal representing the delete status of the encryption key material back to the device (100).

22. The use of the zeroize button (1) of claim 8 to erase encryption key material in a remotely connected encryption system.

23. The use of the zeroize button (1) of claim 8 to erase encryption key information in a connected key token (2).

24. A system comprising one or more computer systems, the system further comprising:
one or more devices (100) as defined in claim 8, the connectors (11) in the devices (100) being connected to the computer systems (3) in a predefined manner for zeroizing of encryption key material in the computer systems (3) and the key tokens (2) in a predefined pattern when the zeroize buttons (1) are operated individually.

25. The system of claim 24, wherein the one or more devices (100) are remotely connected to the computer systems via a wired or wireless communication channel.
